(19) United States
(12) Patent Application Publication
(10) Pub. No.: US 2014/0244343 A1
(43) Pub. Date: Aug. 28, 2014

(54) METRIC MANAGEMENT TOOL FOR DETERMINING ORGANIZATIONAL HEALTH

(71) Applicant: Bank of America Corporation, Charlotte, NC (US)

(72) Inventors: Marlo A. Wilson, Charlotte, NC (US); Robin J. Buck, West Palm Beach, FL (US); John W. Short, Charlotte, NC (US); August M. Pape, Charlotte, NC (US); Daniel P. McCoy, Jacksonville, FL (US); Srinivas Akula, Jacksonville, FL (US); Bharath Aravamuthan, Jacksonville, FL (US); Sudharsan Sundaresan, Jacksonville, FL (US); Fanendra Ganti, Hederabad (IN)

(73) Assignee: BANK OF AMERICA CORPORATION, Charlotte, NC (US)

(21) Appl. No.: 13/774,738

(22) Filed: Feb. 22, 2013

(51) Int. Cl. G06Q 10/06

(52) U.S. Cl. CPC G06Q 10/0635
USPC 705/7.28

(57) ABSTRACT

A metrics management module may be employed to determine organizational health based on data collected for control metrics of an organization. The metrics management module may determine a set of metric health ratings based on the control metric data collected and selects a subset of metric health ratings from the set of metric health ratings. The metrics management module may determine one or more aggregate health ratings based, at least in part, on the subset of selected metric health ratings. The aggregate health ratings may indicate the organizational health of at least a portion of the organization.

### TECHNICAL FIELD

Aspects of the invention generally relate to risk management and governance. In particular, various aspects of the invention include an approach to managing control metrics of an organization in order to determine the operational health of the organization.

### BACKGROUND

Currently, organizations engage in operational risk management to assess, monitor, and address risks the organizations are exposed to. Risks may be internal or external to an organization and may result from the processes, personnel, or systems of the organization. Organizations may also engage in enterprise governance to satisfy enterprise or regulatory standards. An organization may thus implement governance policies to track compliance with those standards as well as to proactively mitigate or avoid operational risks.

The governance policies of an organization may establish various control groups responsible for monitoring the operation of and risks associated with various aspects of the organization. Operational risks may include, for example, risks associated with data management, technology systems, human resources, security, and the like. A control group may define various controls to manage the operation of and risks associated with the aspect of the organization the control group is tasked with overseeing. Controls may include, for example, policies, procedures, and guidelines designed to demonstrate compliance with regulatory requirements or to address identified risks. A control may further define various metrics, which represent quantifiable and measurable parameters an organization may utilize to determine whether the organization has achieved the goals associated with the control metrics. Accordingly, organizations may routinely collect data for these metrics in order to assess risk management efforts or level of compliance.

Conventional approaches to collecting and analyzing metric data, however, may be inefficient, time-consuming, and error-prone. Moreover, conventional approaches may be limited in their ability to summarize the metric data collected as well as in their ability to report on regulatory compliance, risk management, an organizational health. Therefore, a need exists for improved approaches to collecting, analyzing, and reporting control metric data in order to indicate the health of an organization.

### BRIEF SUMMARY

In light of the foregoing background, the following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

Aspects of this disclosure address one or more of the issues mentioned above by disclosing methods, non-transitory computer readable media, and apparatuses for managing control metrics in order to assess organizational health. A metrics management module may be employed to determine organizational health based on data collected for control metrics of an organization.

The metrics management module may determine a set of metric health ratings based on the control metric data collected and may select a subset of metric health ratings from the set of metric health ratings. The metrics management module may determine one or more aggregate health ratings based, at least in part, on the subset of selected metric health ratings. The aggregate health ratings may indicate the organizational health of at least a portion of the organization.

Aggregate health ratings may include control health ratings, control group health ratings, and overall organizational health ratings. Aggregate health ratings may also include related health ratings for related metrics, related controls, and related control groups. Characteristics may be associated with metrics, controls, and control groups to establish relationships between metrics, controls, or control groups that respectively share a common characteristic.

The metrics management module may generate summary health reports that include one or more of the aggregated metrics to indicate the health of metrics, controls, control groups, or the organization overall.

Aspects of the disclosure may be provided in a non-transitory computer-readable medium having computer-executable instructions to perform one or more of the process steps described herein.

This summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

The present invention is illustrated by way of example and is not limited in the accompanying figures in which like reference numerals indicate similar elements.

FIG. 1 shows an illustrative operating environment in which various aspects of the disclosure may be implemented.

FIG. 2 is an illustrative block diagram of a metrics management system that may be used to implement the processes and functions of one or more aspects of the present disclosure.

FIG. 3 is an illustrative diagram of example control groups, controls, and metrics of an organization.

FIG. 4 is an illustrative diagram of example metric, control, and control group health ratings that may be used to determine the health of an organization.

FIG. 5 is an illustrative diagram of example aggregate health ratings based on related metrics, related controls, and related control groups.

FIG. 6 is a flowchart of example method steps for managing control metrics of an organization in order to determine aggregate health ratings for the organization.

FIG. 7 is an example of an implementation of a user interface for configuring a metric.

FIG. 8 is an example of an implementation of a user interface for collecting metric data.

FIG. 9 is an example of an implementation of a first type summary health report that includes aggregate health ratings for an organization.

FIG. 10 is an example of an implementation of a second type of summary health report that includes aggregate health ratings for an organization.

FIG. 11 is an example of an implementation of a third type of summary health report that includes aggregate health ratings for an organization.

FIG. 12 is an example of an implementation of a fourth type of summary health report that includes aggregate health ratings for an organization.

FIG. 13 is an example of an implementation of a fifth type of summary health report that includes aggregate health ratings for an organization.

FIG. 14 is an example of an implementation of a sixth type of summary health report that includes aggregate health ratings for an organization.

FIG. 15 is an example of an implementation of a seventh type of summary health report that includes aggregate health ratings for an organization.

### DETAILED DESCRIPTION

As discussed above there is a need for improvement with the way control metric data is collected, analyzed, and reported in order to determine the operational health of an organization.

In accordance with various aspects of this disclosure, methods, non-transitory computer-readable media, and apparatuses are disclosed in which an organization may collect data for control metrics and analyze the control metric data to assess the health of the organization. An organization may thus use aspects of the disclosure to determine the overall health of the organization or, additionally or alternatively, the health of various aspects of the organization. Organizations may include, for example, companies, government agencies, universities, and the like. Aspects of the organization may include, for example, departments, divisions, personnel groups, technology centers, organizational activity, and the like. Organizational activity may include, for example, data management, service delivery, personnel management, analytics, and the like. With the benefit of this disclosure, it will be understood that aspects of the organization may include additional or alternative types of organizational activity.

In accordance with other aspects of the disclosure, a metric management system may include a metrics management module (e.g., a computing device or a portion thereof) that aids in collecting, analyzing, and summarizing metric data for control metrics of the organization. In particular, the metrics management module may provide interfaces for creating and configuring control groups, controls, and control metrics (“metrics”) for the organization. The metrics management module may also provide interfaces for collecting control metric data and for receiving user input requesting one or more summary health reports of organizational health. As discussed further below, the summary health reports may include aggregated health ratings to indicate organizational health along multiple dimensions.

The metrics management module may be configured to determine organizational health, which may include, for example, the health of metrics, controls, and control groups of an organization as well as the overall health of the organization. In accordance with this disclosure, metric health refers to how close quantifiable metric data for a metric comes to meeting or exceeding a quantifiable target for the metric. In this regard, a metric health rating provides an indication of metric health. A control may be associated with one or more metrics, and thus control health refers to the aggregate health of metrics associated with a control. A control health rating provides an indication of control health based on the aggregated metric health ratings of one or more of the metrics associated with the control.

Similarly, control groups may be associated with one or more controls, and thus control group health refers to the aggregate health of the controls associated with a control group. Control group health may also refer to the aggregate health of the metrics for controls associated with the control group. A control group health rating may therefore provide an indication of control group health based on aggregated control health ratings of one or more of the controls associated with the control group. The control group health rating may alternatively provide an indication of control group health based on the aggregated metric health ratings of one or more of the metrics for the controls associated with the control group.

An organization may establish multiple control groups, and thus overall organizational health refers to the aggregate health of control groups of the organization. Overall organizational health may also refer to the aggregate health of the controls of the organization or the aggregate health of the metrics of the organization. An overall health rating may therefore provide an indication of the overall health of the organization based on aggregated control group health ratings of one or more control groups of the organization. The overall health rating may additionally or alternatively provide an indication of the overall health of the organization based on aggregated control health ratings of one or more controls of the organization or based on aggregated metric health ratings of one or more metrics of the organization.

Organizational health may also refer to the health of related metrics, related controls, and related control groups. As discussed further below, various characteristics may be associated with metrics, controls, and control groups to respectively establish relationships between multiple metrics, multiple controls, and multiple control groups. Accordingly, related metric health refers to the aggregate health of related metrics; related control health refers to the aggregate health of related controls; and related control group health refers to the aggregate health of related control groups. A related metric health rating may indicate the health of related metrics based on the aggregated metric health ratings of the related metrics; a related control health rating may indicate the health of related controls based on aggregated control health ratings of related controls; and a related control group health rating may indicate the health of related control groups based on aggregated control group health ratings of related control groups.

Health ratings may be values that respectively quantify metric health, control health, control group health, and so on. Additionally or alternatively, the health ratings may be visual indicators that visually indicate the metric health, control health, control group health, and so on. For example, a health rating may be a color-coded status indicator that uses various colors (e.g., green, yellow, red) to visually indicate metric health, control health, control group health, and so on. Additionally, it will be understood that additional or alternative approaches may be selectively employed to determine or to indicate metric health, control health, control group health, and so on.

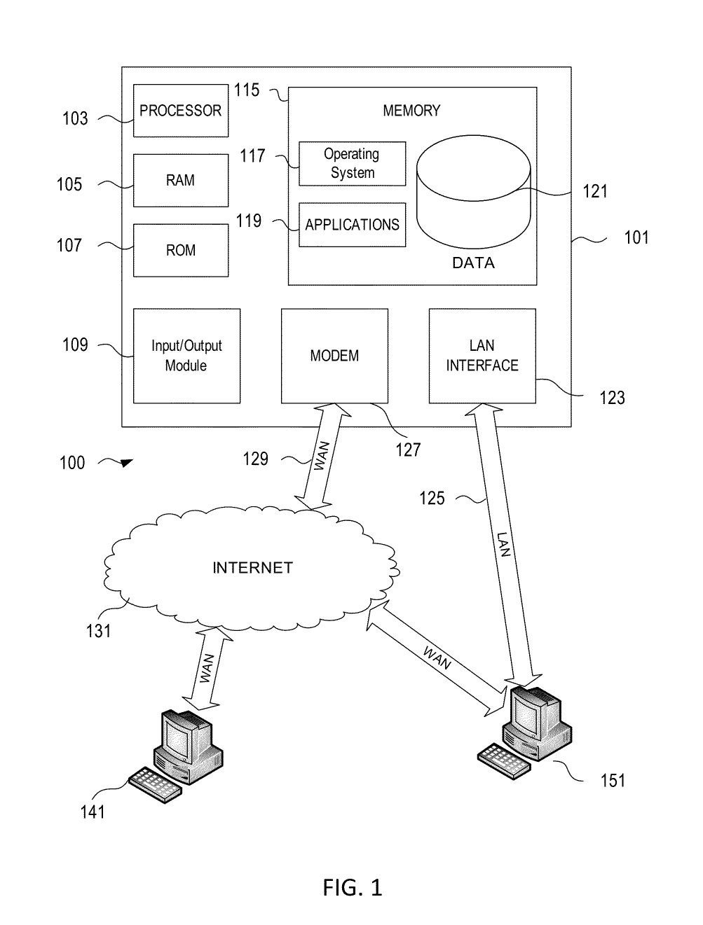

FIG. 1 illustrates a block diagram of an example of an implementation of a metrics management system 100. The metrics management system 100 includes a metrics management module 101, which is shown in this example as a computing device. The computing device 101 may have a processor 103 for controlling overall operation of the metrics management module 101 and its associated components, including RAM 105, ROM 107, an input/output (I/O) module 109, and memory 115.

I/O module 109 may include a microphone, keypad, touch screen, and/or stylus through which a user of the computing device 101 may provide input, and may also include one or more of a speaker for providing audio output and a video display device for providing textual, audiovisual and/or graphical output. Software may be stored within memory 115 and/or storage to provide instructions to the processor 103 for enabling the computing device 101 to perform various functions. For example, memory 115 may store software used by the computing device 101, such as an operating system 117, application programs 119, and an associated database 121. The processor 103 and its associated components may allow the computing device 101 to run a series of computer-readable instructions to collect, analyze, and summarize control metric data as well as to determine the operational health of an organization based on the control metric data.

The computing device 101 may operate in a networked environment supporting connections to one or more remote computers, such as terminals 141 and 151. The terminals 141 and 151 may be personal computers or servers that include many or all of the elements described above relative to the computing device 101. Alternatively, terminal 141 and/or 151 may be a data store that is affected by the operation of the metrics management module 101. The network connections depicted in FIG. 1 include a local area network (LAN) 125 and a wide area network (WAN) 129, but may also include other networks. When used in a LAN networking environment, the computing device 101 is connected to the LAN 125 through a network interface or adapter 123. When used in a WAN networking environment, the computing device 101 may include a modem 127 or other means for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP and the like is presumed.

Additionally, an application program 119 used by the metrics management module 101 according to an illustrative embodiment of the disclosure may include computer-executable instructions for invoking functionality related to collecting, analyzing, and summarizing control metric data as well as functionality related to determining the operational health of an organization based on the control metric data.

The metrics management module 101 and/or terminals 141 or 151 may also be mobile terminals, such as smart phones, personal digital assistants (PDAs), and the like, which may include various other components, such as a battery, speaker, and antennas (not shown).

The disclosure is operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, and distributed computing environments that include any of the above systems or devices, and the like.

The disclosure may be described in the general context of computer-executable instructions, such as program modules, being executed by a computer. Generally, program modules include routines, programs, objects, components, data structures, and the like that perform particular tasks or implement particular abstract data types. The disclosure may also be practiced in distributed computing environments where tasks are performed by remote processing devices that are linked, for example, through a communications network. In a distributed computing environment, program modules may be located in both local and remote computer storage media including memory storage devices.

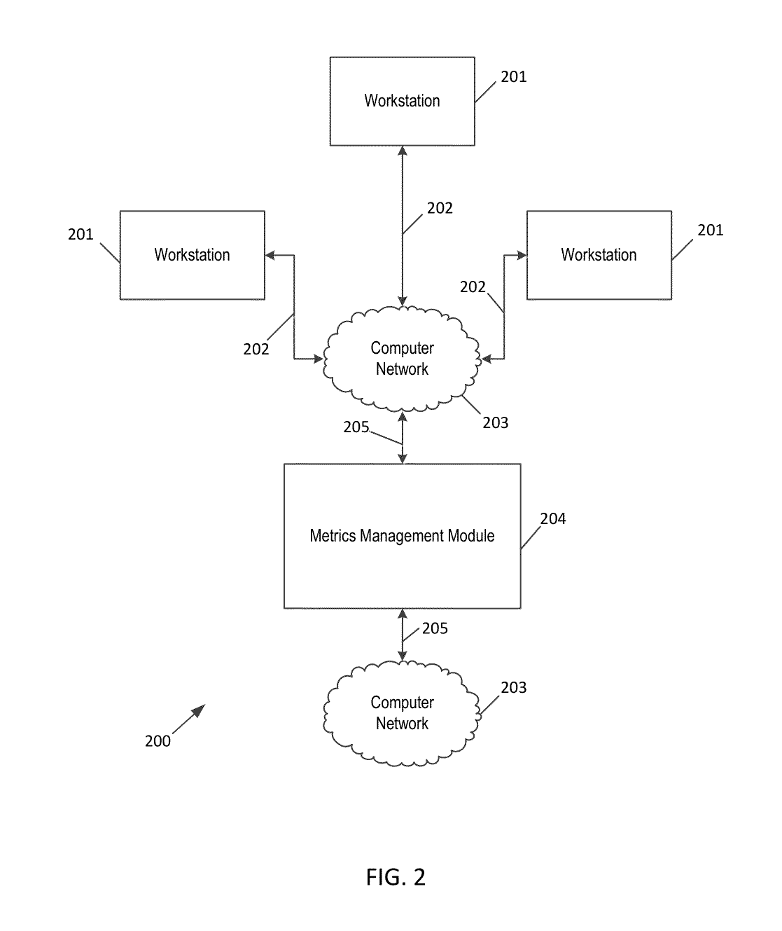

Referring to FIG. 2, an illustrative metrics management system 200 for implementing methods according to the present disclosure is shown. As illustrated, the metrics management system 200 may include one or more workstations/servers 201. The workstations 201 may be local or remote, and are connected by one or more communications links 202 to a computer network 203 that is linked via communications links 205 to the metrics management module 204. In certain embodiments, the workstations 201 may be different points at which the metrics management module 204 may be accessed. In system 200, the metrics management module 204 may be any suitable server, processor, computer, or data processing device, or combination of the same.

The computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. The communications links 202 and 205 may be any communications links suitable for communicating between the workstations 201 and the metrics management module 204, such as network links, dial-up links, wireless links, hard-wired links, and the like. The disclosure that follows may be implemented by one or more of the components in FIGS. 1 and 2 and/or other components, including other computing devices.

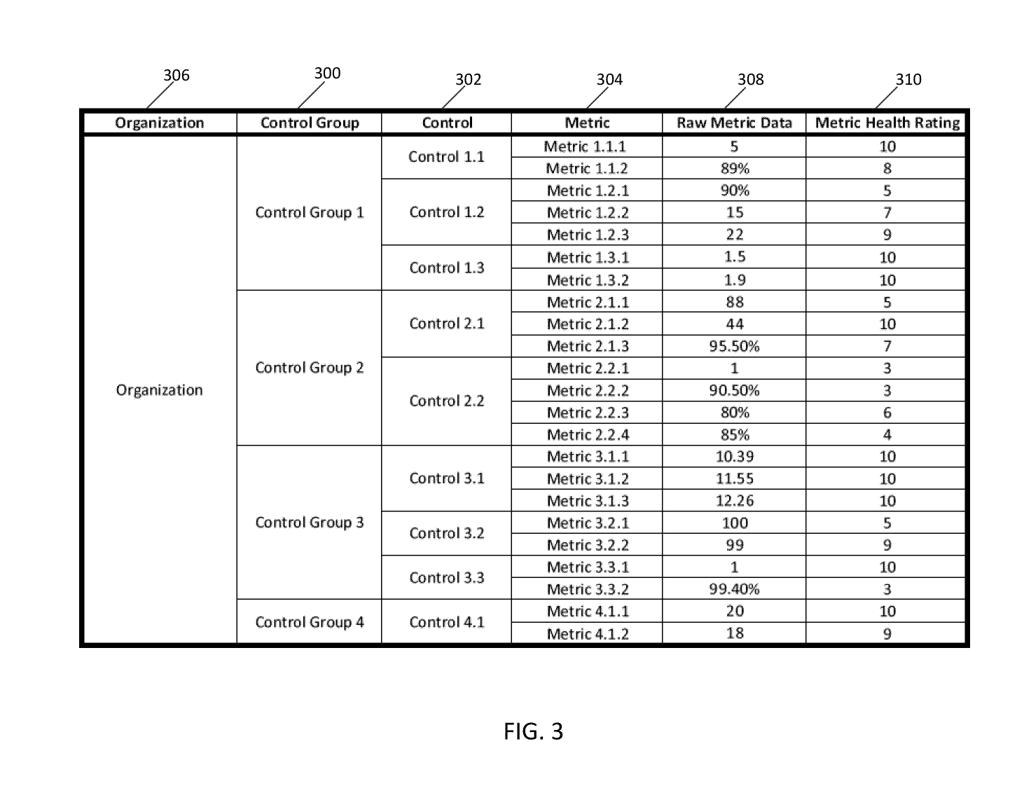

FIG. 3 is a representational diagram of example control groups 300, controls 302, and metrics 304 that an organization 306 may define for governance or risk management purposes. As seen in this example, an organization 306 may establish a set of control groups 300. Each control group 300 may be associated with a set of controls 302, and each control 302 may be associated with a set of metrics 304. As used in this disclosure, a set refers to a collection of one or more elements. In this regard, a set of control groups 300 for the organization 306 includes one or more control groups 300, a set of controls 302 for a control group 300 includes one or more controls, and a set of metrics 304 for a control 302 includes one or more metrics 304. The organization 306 may collect raw metric data 308 for the metrics 304 at periodic intervals, e.g., on a monthly basis. The metrics management module may store the raw metric data 308 for the metrics 304 in a data storage device such as the database 121 of FIG. 1. As seen in FIG. 3, the raw metric data 308 may be in a variety of quantifiable formats including percentages, decimals, and integers.

While FIG. 3 uses generic names for the control groups 300, controls 302, and metrics 304, an example of a control group may be a control group for enterprise data management that is tasked with overseeing how data is managed within an organization. In this example, the data management control group may define controls associated with the management of data within the organization such as, for example, a data retention control and a data security control. The data management control group may define a data backup metric for the data retention control, which specifies when and how often the organization should backup its critical data (e.g., every night at midnight). Accordingly, the raw metric data for the data backup metric may quantify compliance with the metric by indicating how often the organization successfully completed the data backup procedure (e.g., 22 times for the month of August, 25 times for the month of September, and so on). With the benefit of this disclosure, it will be understood that an organization 306 may establish and define additional or alternative control groups 300, controls 302, and metrics 304.

The metrics management module may convert the raw metric data 308 to a metric health rating 310 for a metric 304. In this regard, the metrics management module may normalize the raw metric data 308 to obtain a set of metric health ratings 310 that can subsequently be aggregated to determine aggregate health ratings. Based on the diagram shown in FIG. 3, it can be seen that the metrics management module may determine aggregate health ratings along a variety of different dimensions. The metrics management module may select a subset of metric health ratings from the set of metric health ratings 310 and aggregate the selected metric health ratings of the subset to determine and obtain aggregate health ratings based, at least in part, on the subset of metric health ratings. Aggregate health ratings may include, for example, control health ratings for the controls 302 of the organization 306, control group health ratings for the control groups 300 of the organization 306, and an overall organizational health rating.

Accordingly, a control health rating may be one of a set of control health ratings, and the metrics management module may select a subset of control health ratings from the set of control health ratings to determine and obtain a control group health ratings based, at least in part, on the subset of control health ratings. A control health rating may indicate the health of a control of the organization. The control group health rating may likewise be one of a set of control group health ratings, and the metrics management module may determine and obtain an overall health rating for the organization based, at least in part, on the set of control group health ratings or a subset of control group health ratings. A control group health rating may indicate the health of a control group of the organization.

As used in this description, the subset of selected metric health ratings refers to one, some, or all of the metric health ratings 310 of the set of metric health ratings. Likewise, the subset of control health ratings and the subset control group health ratings respectively refer to one, some, or all of the control health ratings of the set of control health ratings, and one, some, or all of the control group health ratings of the set of control group health ratings. In sum, metric health ratings 310 are based on the raw metric data 308, control health ratings may be based on aggregated metric health ratings, control group health ratings may be based on aggregated control health ratings, and the overall organizational health rating may be based on aggregated control group health ratings.

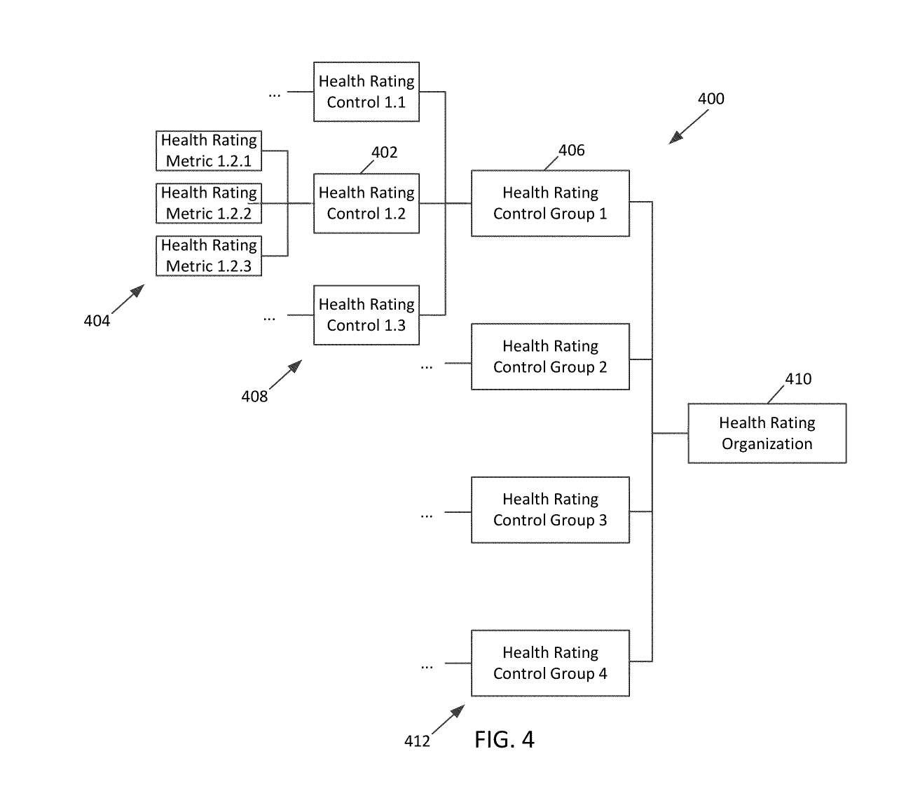

With reference to FIG. 4, the following examples illustrate the flexibility of the metrics management module to determine aggregate health ratings 400 that indicate organizational health along various dimensions. The metrics management module may determine a control health rating 402 for “Control 1.2” by aggregating the metric health ratings of a set of metric health ratings 404 for metrics associated with the control. The metrics management module may also determine a control group health rating 406 for “Control Group 1” by determining and aggregating control health ratings of a set of control health ratings 408 for controls associated with the control group. Furthermore, the metrics management module may determine an overall organizational health rating 410 by determining and aggregating control group health ratings for a set of control group health ratings 412 for control groups associated with the organization. The metrics management module may respectively determine metric health ratings 404, control health ratings 408, and control group health ratings 412 for the other metrics, controls, and control groups of the organization in a similar fashion. The set of metric health ratings 404, the set of control health ratings 408, and the set of control group health ratings 412 may also be respectively understood as a subset of metric health ratings, a subset of control health ratings, and a subset of control group health ratings.

Continuing the example of the data backup metric, the metrics management module may convert the raw metric data for this metric into a metric health rating. The metrics management module may then aggregate the metric health rating for the data backup metric with metric health ratings for other metrics of the data retention control to obtain a control health rating. In turn, the metrics management module may aggregate the control health rating for the data retention control with other control health ratings of the data management control group to obtain a control group health rating. Finally, the metrics management module may aggregate the control group health rating for the data management control group with other control group health ratings to obtain an overall organizational health rating.

Aggregate health ratings may also include related metric health ratings, related control health ratings, and related control group health ratings. Metrics, controls, and control groups may be associated with various characteristics to establish relationships between metrics that share a common metric characteristic, between controls that share a common control characteristic, and between control groups that share a common control group characteristic. In this way, the metrics management module may respectively determine related metric health ratings, related control health ratings, and related control group health ratings for the shared metric characteristic, the shared control characteristic, and the shared control group characteristic.

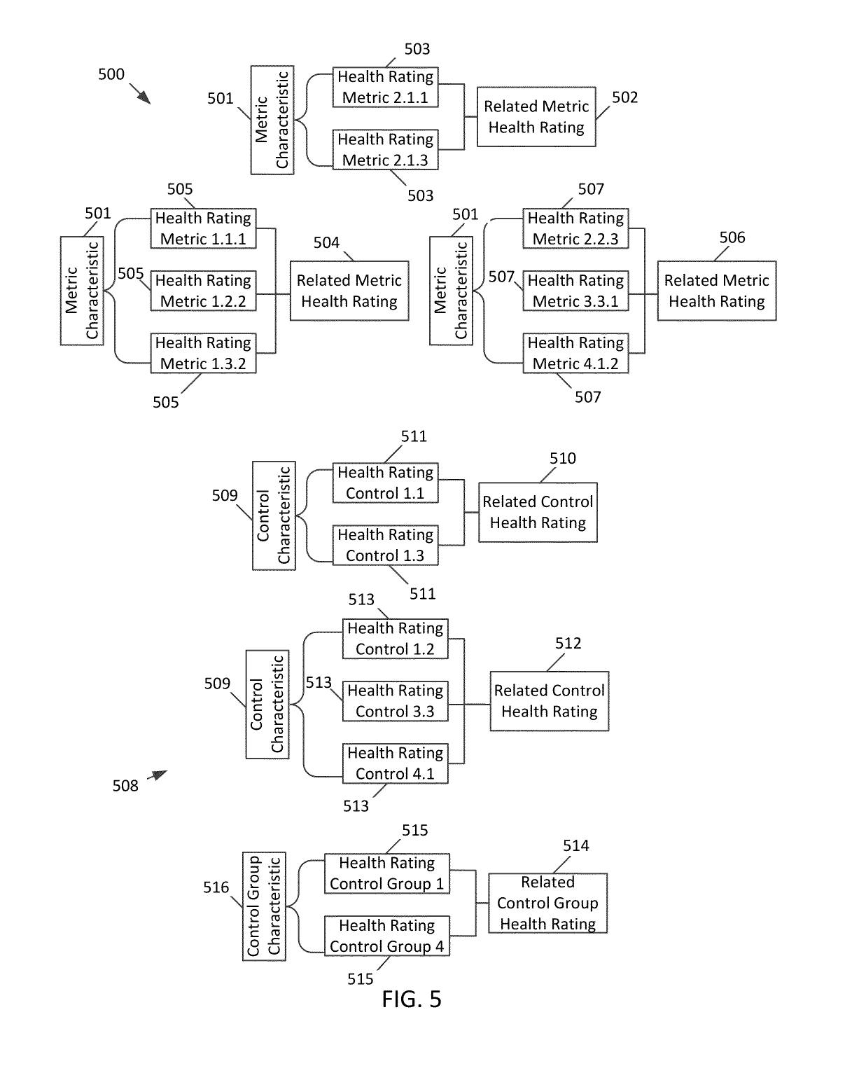

FIG. 5 illustrates examples of related metric health ratings 500 for metrics related by a common metric characteristic 501 including: a related metric health rating 502 for related metrics 503 within the same control; a related metric health rating 504 for related metrics 505 from different controls within the same control group; and a related metric health rating 506 for related metrics 507 from controls of different control groups related by a common metric characteristic.

FIG. 5 also illustrates example of related control health ratings 508 for controls related by a common control characteristic 509 including: a related control health rating 510 for related controls 511 within the same control group; and a related control health rating 512 for related controls 513 from different control groups. FIG. 5 further includes an example of a related control group health rating 514 for control groups 515 related by a common control group characteristic 516.

It will be understood that FIG. 5 illustrates the related metric health ratings 500, the related control health ratings 508, and the related control group health rating 514 by way of example only, and the metrics management module may determine aggregate health ratings based on additional or alternative combinations of metric health ratings, control health ratings, and control group health ratings. As demonstrated in FIG. 5, the metrics management module advantageously provides the ability to flexibly aggregate health ratings along different dimensions.

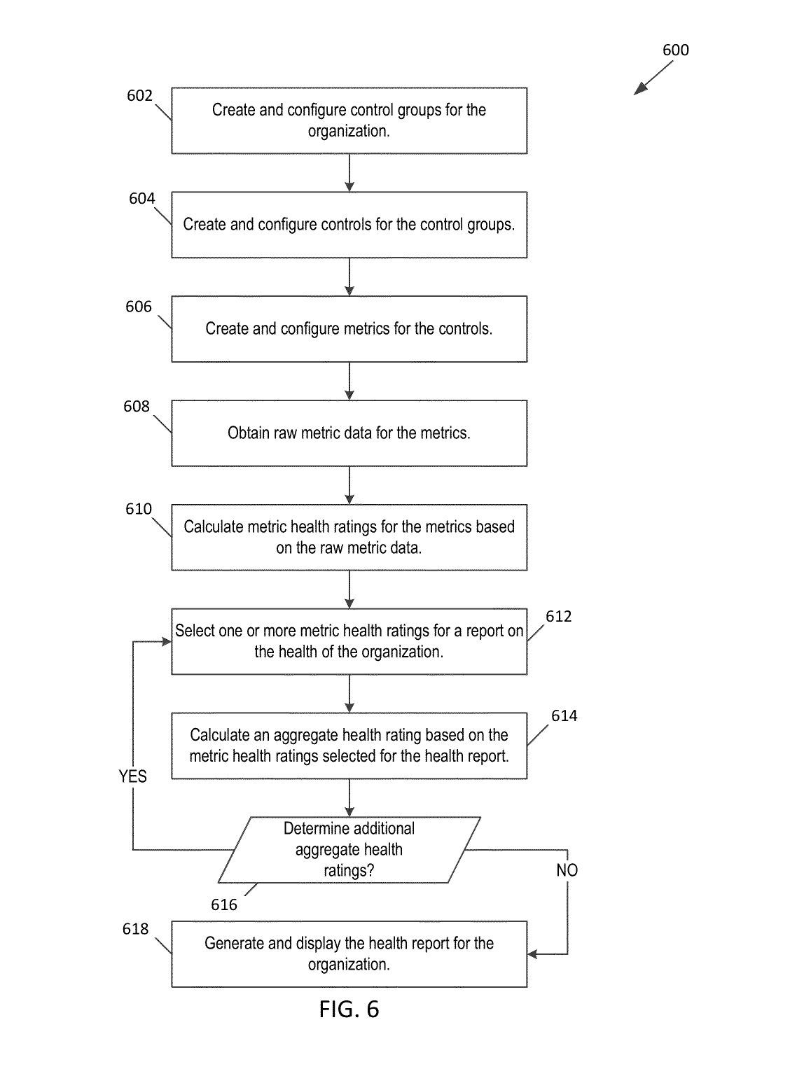

Referring now to FIG. 6, a flowchart 600 of example method steps for managing metrics to determine organizational health is shown. An organization may begin by creating and configuring one or more control groups (step 602). Configuration information for a control group may include, for example, a unique identifier, an abbreviation, a control group name, and a control group owner. The metrics management module may store control group configuration information at a database (e.g., database 121 of FIG. 1) in one or more records to configure the one or more respective controls for the control groups (step 604). Having created the control groups, the organization may then create one or more controls for each control group. Information for a control may include, for example, a unique identifier, a control name, a description, and the control group the control is associated with. The metrics management module may also store control configuration information at a database in one or more records of one or more database tables.

The organization may then create and configure one or more respective metrics for the controls (step 606). Once the metrics have been created and configured, the metrics management module may collect the raw metric data for the metrics (step 608). Raw metric data may be collected at a periodic interval such as, for example, every month. Employees of the organization may provide the raw metric data to the metrics management module via, for example, a web portal at one of the terminals 141 or 151 of FIG. 2. Additional or alternative approaches may be selectively employed to collect the raw metric data. The metrics management module may store the raw metric data at a database in one or more records of one or more database tables such that the raw metric data is associated with the appropriate metric.

The metrics management module may determine metric health ratings for the metrics based on the raw metric data collected (step 610). The metrics management module may process, modify, or transform the raw metric data, which may include normalizing the raw metric data, scaling the raw metric data, and the like in order obtain respective metric health ratings for the metrics. As discussed further below, normalization of the raw metric data may be based on metric thresholds established for a metric, e.g., a lower threshold, a middle threshold, and an upper threshold. As an example, the metrics management module may normalize raw metric data at or below the lower threshold to a metric health rating of 33; may normalize raw metric data between the middle threshold to a metric health rating of 66; and may normalize raw metric data above the upper threshold to a metric health rating of 100. Normalizing the raw metric data to obtain metric health ratings for the metrics enables the metrics management module to aggregate the metric health ratings and obtain the aggregated health ratings. As noted above, the metrics management module may aggregate metric health ratings to determine control health ratings, control group health ratings, an overall organizational health rating, and related health ratings for related metrics, controls, and control groups.

The metrics management module may generate various summary health reports based on the aggregated health ratings. The metrics management module may select a subset of one or more metric health ratings in order to generate a summary health report that indicates organizational health (step 612). The metrics management module may select the metric health ratings based on, for example, user input received from a user. As an example, a user may request that the metrics management module generate a summary health report for various metric characteristics. The metrics management module may thus select a subset of metric health ratings that includes metrics associated with a metric characteristic. The metrics management module may determine an aggregate health rating based on the subset of selected metric health ratings (step 614). If additional aggregate health ratings remain to be determined (step 616), then the metrics management module may select an additional subset of metric health ratings (step 612) and determine an additional aggregate health rating based on the additional subset of selected metric health ratings (step 614), e.g., a subset of metric health ratings that includes metrics associated with another one of the metric characteristics. Once the metric management module has determined the all of aggregate health ratings for the summary health report, the metrics management module may generate and display the summary health report (step 618). Steps 602-610 may be repeated on a periodic basis (e.g., monthly) to monitor metric health over time. Likewise, steps 612-618 may be repeated as needed to assess organizational health. It will also be understood that determining an aggregate health rating (step 614) may include determining a control health rating, a control group health rating, an overall health rating, or a related health rating and that the summary health report may include these additional types of aggregate health ratings.

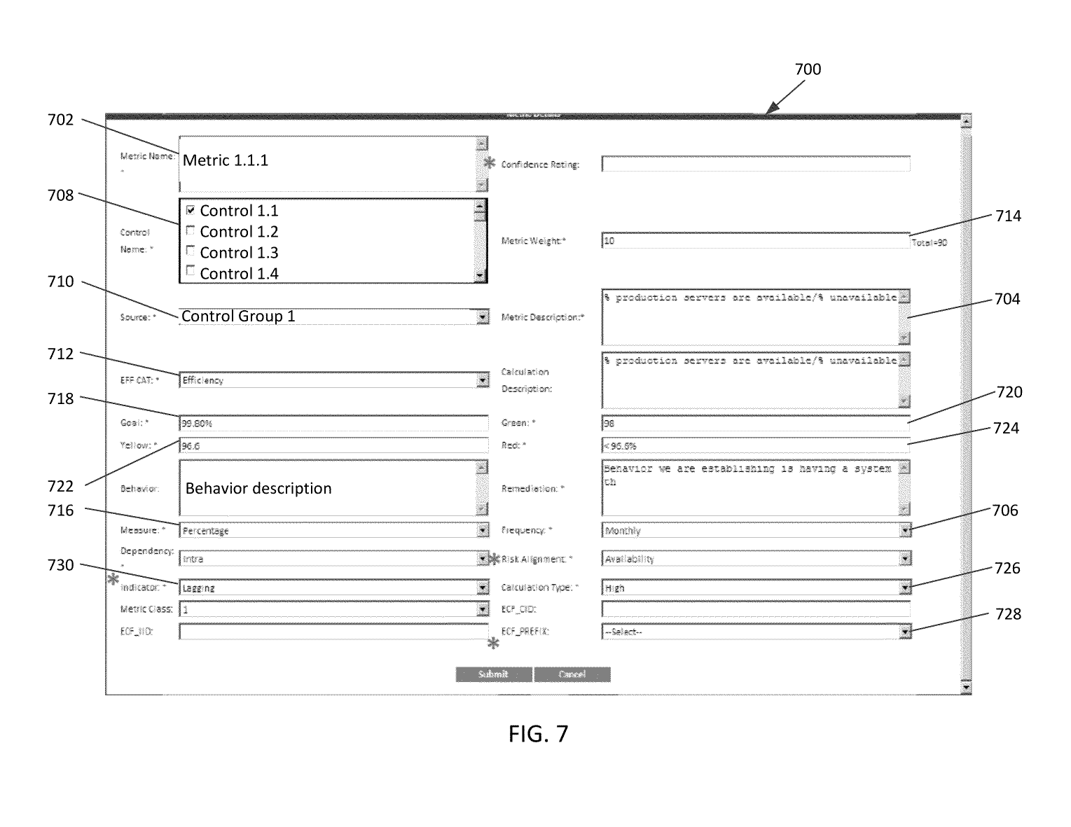

FIG. 7 is an example of an implementation of an interface 700 for configuring a metric for a control. The metrics management module may present the interface 700, for example, via a web portal at one of the terminal devices 141 and/or 151 of FIG. 1 or via a display device of the I/O module 109 as part of an application 119 at the computing device 101 of FIG. 1.

As seen in FIG. 7, metric configuration information may include, for example, a metric name 702, a description 704, the frequency 706 with which metric data is collected for the metric, the control 708 the metric is associated with, and the control group 710 the metric is associated with. In some example implementations, a metric may be associated with multiple controls as shown by way of example in FIG. 7. Metric configuration information may also include a category 712 that categorizes the metric as an efficiency metric or an effectiveness metric. Metric configuration information may additionally include a metric weight 714 that the metrics management module may utilize when determining metric health ratings.

Metric configuration information may further include a measurement type 716 (e.g. a percentage), a metric goal 718, and various performance thresholds 720, 722, 724 such as an upper performance threshold 720, a middle performance threshold 722, and a lower performance threshold 724. In this example, the metrics management module may automatically color code a visual indicator for the metric based on the normalized metric health ratings and the performance thresholds 720, 722, 724. Using the example above, a metric health rating of 100 may be associated with a green-colored visual indicator; a metric health rating of 66 may be associated with a yellow-colored visual indicator; and a metric health rating of 33 may be associated with a red-colored visual indicator. In this example, a green-colored visual indicator may indicate the metric is healthy, a yellow-colored visual indicator may indicate that the metric is between healthy and unhealthy, and a red-colored visual indicator may indicate that the metric is unhealthy.

As mentioned above, metrics may also be associated with various characteristics in order to establish relationships among metrics that share common characteristics. Characteristics may map to both enterprise standards as well as to regulatory standards. By associating metrics with various characteristics, the metrics management module advantageously provides more effective and efficient assessments of organizational health with respect to those standards. Moreover, the metrics management module may be updated to add new metric characteristics or revise existing metric characteristics to accommodate additions or updates to the enterprise standards or regulatory standards.

The metric characteristics shown by way of example in FIG. 7 include a risk alignment characteristic 726 that relates metrics based on risk alignment categories, an enterprise control framework (ECF) characteristic 728 that relates metrics based on an ECF prefix, and a leading/lagging indicator characteristic 730 that relates metrics based on their status as a leading or lagging indicator. Lagging indicators relate to information regarding events that have already occurred, e.g., the number of hard disk failures that occurred in the previous month. Leading indicators relate to information that may impact future events that have not yet occurred, e.g., the average age of hard disks in use. Accordingly, the predictive nature of leading indicators may allow for remedial action that improves the outcome of a lagging indicator, e.g., replacing hard disks on a regular basis to reduce their average age thereby reducing the occurrence of hard disk failures. Other types of metric configuration information may include a confidence rating 732, a dependency 734, and calculation type 736. Confidence rating 732, in this example, refers to the validity of the metric. A metric may be a valid metric and thus associated with a relatively high confidence rating when the metric is aligned to a business process, frequently reported, and the type of data collected for the metric aligns to an industry standard for the control. Dependency 734, refers to relationships between metrics and control groups, i.e., whether a metric dependent on the performance of another metric or control group (inter-dependent) or whether the metric is only dependent on the performance control group it is associated with (intra-dependent). Calculation type 736 refers to whether high scores or low scores are desired for the metric, i.e., whether the metric will be considered healthy if the raw metric data is a high or low number. It will be understood with the benefit of this disclosure that additional or alternative types of metric configuration information and metric characteristics may be selectively employed. The metrics management module may likewise store the metric configuration information at a database in one or more records of one or more database tables.

As noted above, controls and control groups may similarly include characteristics that establish relationships between controls that share a common control characteristic and between control groups that share a common control group characteristic. Control groups, for example, may be related based on a common control group owner assigned to the control groups. The control group owner may represent a control group characteristic that establishes a relationship between control groups.

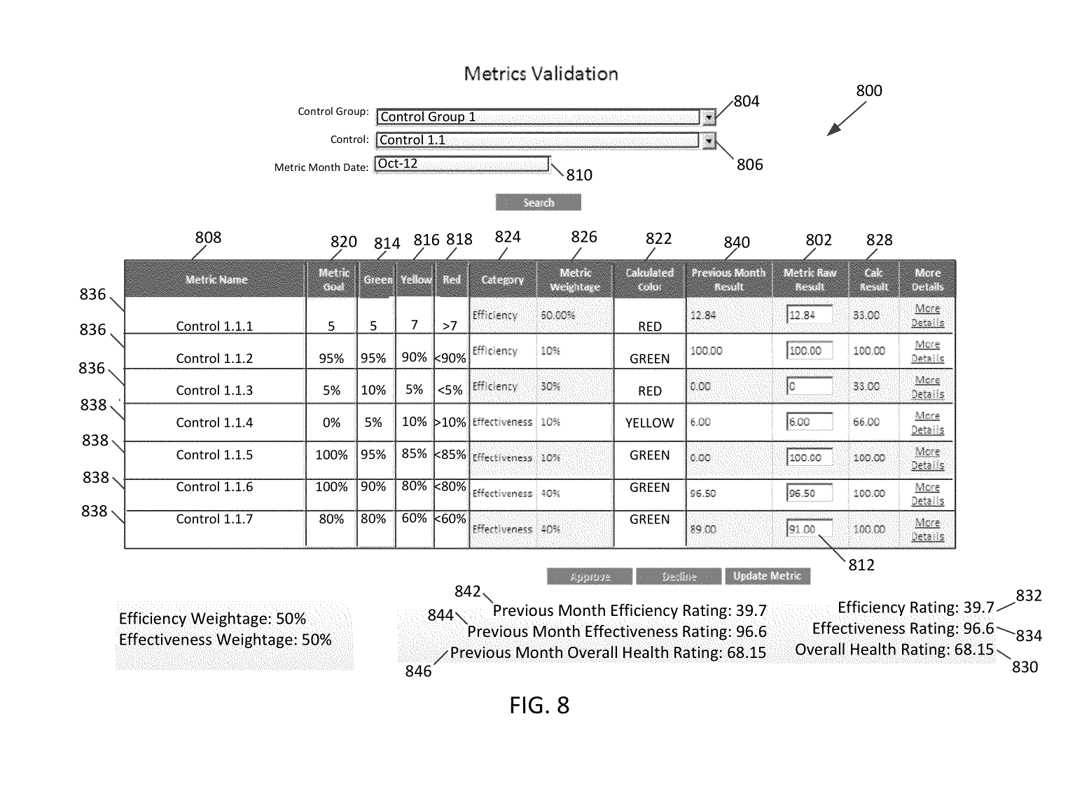

FIG. 8 is an example of an implementation of a user interface 800 for collecting the raw metric data 802. As seen in FIG. 8, a user may select a control group 804 and a control 806 at the interface 800 in order to display the metrics 808 associated with the selected control 806. The user may also select the month 810 that corresponds to the raw metric data 802 being collected. In this way, the metrics management module may provide monthly reports of organizational health. The metrics management module may, in some example implementations, present the interface 800 at a web portal of one of the terminal devices 141 or 151 of FIG. 1 as described above. The interface 800 includes user interface elements 812 (e.g., textboxes) for receiving the raw metric data 802 from a user. The metrics management module may store the raw metrics data 802 in one or more records of one or more database tables of a database such that the raw metric data 802 is associated with a corresponding metric 808.

The metrics management module may automatically determine the appropriate color code for a metric 808 based on the raw metric data 802 and the performance thresholds 814, 816, 818 defined for the metric 808 as discussed above with respect to FIG. 7. The interface 800 may also include the metric goal 820 and a color-coded visual indicator 822 as shown by way of example in FIG. 8. The interface 800 may also include, for example, respective category 824 and metric weight 826 for the metric 808. The interface 800 may include metric health ratings 828 for the metrics 808 normalized from the raw metric data 802. It will be understood that the interface 800 may include additional or alternative configuration information for the metrics 808, the selected control 806, or the selected control group 804.

Having obtained the metric health ratings 828, the metrics management module may, in turn, determine a control health rating 830 for the selected control 806 based on the metric health ratings of the metrics 808 associated with the selected control. In some example implementations, the control health rating 830 may be based on two aggregated health ratings: an efficiency health rating 832 and an effectiveness health rating 834. The efficiency health rating 832 may be based on the metric health ratings 828 of metrics 836 categorized as efficiency metrics, and the effectiveness health rating 834 may be based on metrics 383 categorized as effectiveness metrics. For example, the efficiency health rating 832 may be the sum of the metric health ratings 828 of the efficiency metrics 836, and the effectiveness health rating 834 may be the sum of the metric health ratings 828 of the effectiveness metrics 838. The metrics management module may determine the control health rating 830 based on the efficiency health rating 832 and the effectiveness health rating 834. In particular, the control health rating 836 in this example is the arithmetic mean of the efficiency health rating 832 and the effectiveness health rating 834 of the control 806. The metrics management module may, in some example implementations, multiply the metric health ratings 828 by their respective weights 826 and sum the weighted metric health ratings to determine the efficiency health rating 832 and the effectiveness health rating 834. It will be understood with the benefit of this disclosure that the metrics management module may employ alternative approaches to determine metric health ratings 828, the control health ratings 830, or other aggregated health ratings.

The interface 800 may include raw metric data, metric health ratings, or aggregated health ratings for previous months. In the example interface 800 of FIG. 8, the interface includes previous raw metric data 840, previous efficiency and effectiveness health ratings 842 and 844, and a previous control health rating 846 for the prior month. In this way, users may monitor trends in changes to metric health and control health.

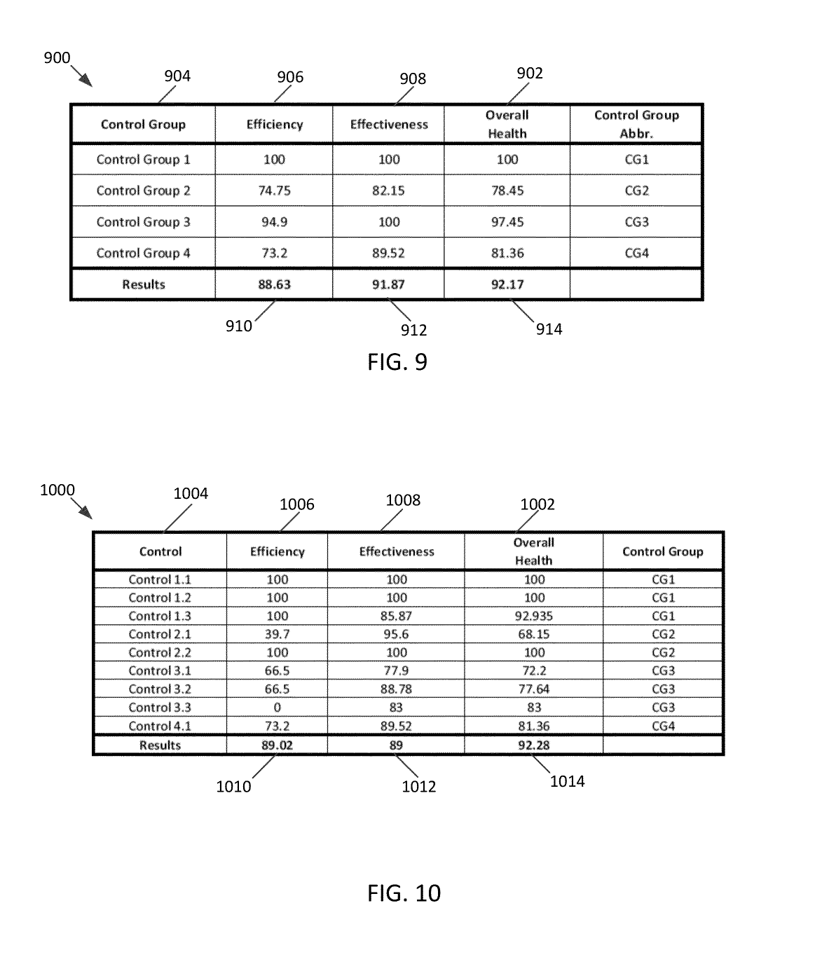

FIGS. 9-15 are illustrative examples of summary health reports that the metrics management module may generate based on the metric health ratings. In FIG. 9, the aggregate health ratings of the example summary health report 900 include control group health ratings 902 that indicate the health of the control groups 904 of the organization. The example control group health ratings 902 in FIG. 9 are respectively based on aggregated efficiency health ratings 906 and aggregated effectiveness health ratings 909 (e.g., the arithmetic mean). The aggregated health ratings in the example summary health report of FIG. 9 also include an overall efficiency health rating 910 based on the aggregated efficiency health ratings 906 for the control groups 904, an overall effectiveness health rating 912 based on the aggregated effectiveness health ratings 908 for the control groups, and an overall health rating 914 for the organization based on the control group health ratings 902 for the control groups.

In FIG. 10, the aggregate health ratings of the example summary health report 1000 include control health ratings 1002 that indicate the health of the controls 1004 of the organization. The control health ratings 1002 in the summary health report 1000 of FIG. 10 are respectively based on efficiency health ratings 1006 and effectiveness health ratings 1008 for the controls 1004. As discussed above, the efficiency health ratings 1006 and the effectiveness health ratings 1008, in this example, are aggregate health ratings based on the metric health ratings of the metrics respectively associated with the controls 1004 that are categorized as either efficiency metrics or effectiveness metrics respectively. The aggregated health ratings in the example summary health report 1000 of FIG. 10 also include an overall efficiency health rating 1010 based on the aggregated efficiency health ratings 1006 for the controls 1004, an overall effectiveness health rating 1012 based on the aggregated effectiveness health ratings 1008, and an aggregated control health rating 1014 for the list of controls based on the control health ratings 1002 for the controls.

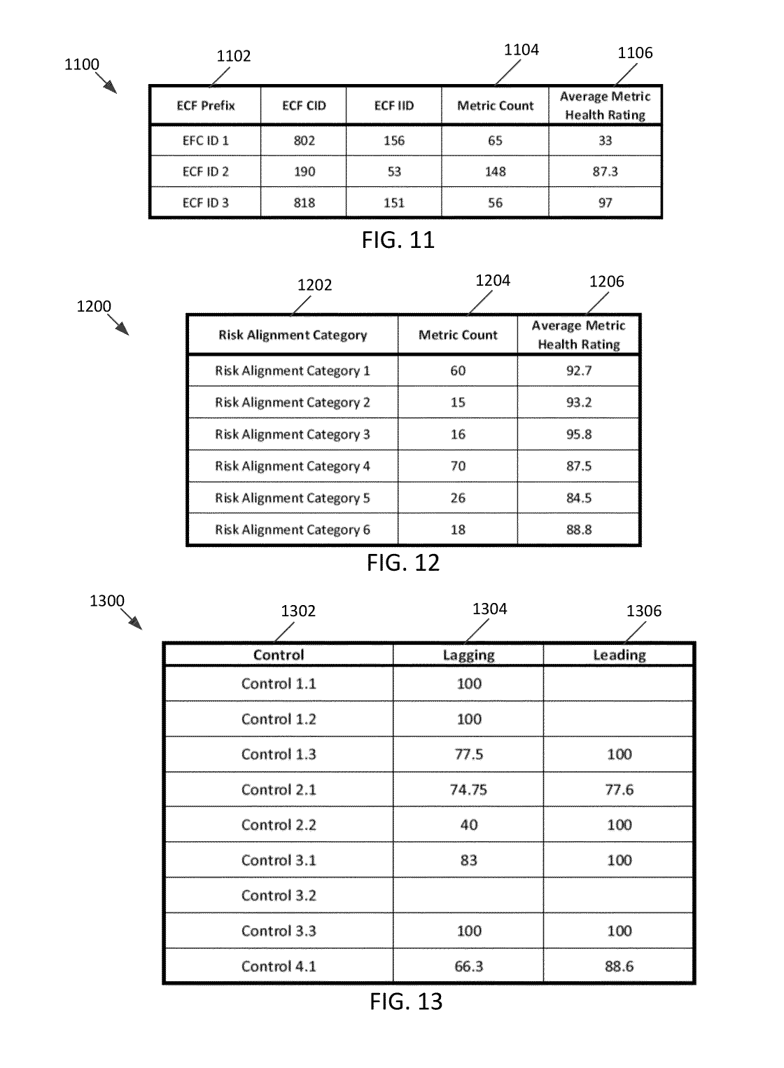

In some circumstances, auditors or regulators may request from an organization information that indicates the level of compliance with ECF standards. As discussed above, metrics may be related by ECF prefix. Accordingly, the metrics management module may generate a summary health report that includes aggregated health ratings for metrics related by ECF prefix to demonstrate the level of compliance with ECF standards. FIG. 11 is an illustrative example of a summary health report 1100 for metrics related by ECF prefix. The summary health report 1100 of FIG. 11 includes a list of ECF prefixes 1102, the number of metrics 1104 associated with the respective ECF prefixes, and aggregate health ratings 1106 for metrics related by ECF prefix. In this way, the metrics management module advantageously provides a relatively quick and efficient way to assess compliance with ECF standards.

An organization may also desire to assess its risk alignment. As also discussed above, metrics may include a risk alignment characteristic that relates metrics based on risk alignment categories. Accordingly, the metrics management module may generate a summary health report that includes aggregated health ratings for metrics related by risk alignment category to illustrate the risk alignment of the organization. FIG. 12 is an illustrative example of a summary health report 1200 for metrics related by risk alignment category. The summary health report 1200 of FIG. 12 includes a list of risk alignment categories 1202, the number of metrics 1204 associated with the respective risk alignment categories, and aggregate health ratings 1206 for metrics related by risk alignment category. In this way, the metrics management module advantageously provides a relatively quick and efficient way to assess the risk alignment of an organization.

FIG. 13 is an illustrative example of a summary health report 1300 based on a leading/lagging indicator characteristic. In particular, the summary health report 1300 of FIG. 13 includes two types of aggregated health ratings for the controls 1302, an aggregated lagging indicator health rating 1304 and an aggregated leading indicator health rating 1306. The aggregated lagging indicator health rating 1304, in this example, is based on the aggregated metric health ratings of metrics associated with a lagging indicator characteristic. The leading indicator health rating 1306, in this example, is based on the aggregated metric health ratings of metrics associated with a leading indicator characteristic. In this way, the metrics management module advantageously provides a relatively quick and efficiency way to collectively assess the lagging and leading metrics of controls of the organization.

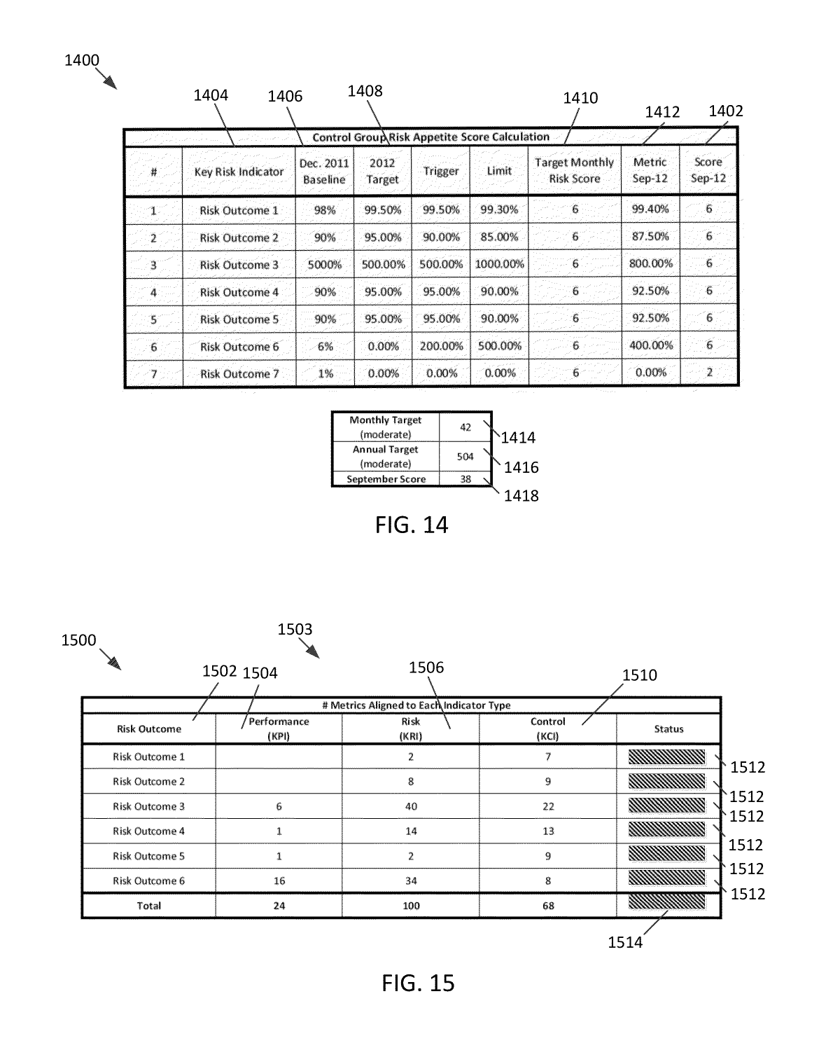

Auditors or regulators may also seek to assess the risk appetite of an organization. In this regard, the metrics management module may generate a summary health report that represents a risk appetite scorecard for the organization. Metrics of the organization may be associated with a risk outcome characteristic, and the risk appetite scorecard may include aggregate health ratings based on metric health ratings for metrics related by risk outcome. FIG. 14 is an illustrative example of a risk appetite scorecard 1400 that includes aggregate health ratings 1402 for various risk outcomes 1404. The summary health report 1400 of FIG. 14 includes for each risk outcome 1404 in the risk appetite scorecard a baseline metric measurement 1406 for the previous year, a target metric measurement 1408 for the current year, a target metric health rating 1410 for the current month, the raw metric data 1412 for the current month, and the actual metric health ratings 1402 for the current month.

In addition, the metrics management module may also include in the risk appetite scorecard 1400 an aggregated target health rating 1414 for the current month, an aggregated target health rating for the current year 1416, and an actual aggregate health rating 1418 for the current month. In this example, the actual aggregate health rating 1418 for the current month is based on the actual metric health ratings 1402 of each risk outcome 1404 for the current month. In this way, the metrics management module advantageously provides a relatively quick and efficient way for auditors to assess the risk appetite of an organization as well as any trends in changes to the health of risk outcomes over previous months and previous years.

FIG. 15 is an illustrative example of another type of summary health report 1500 the metrics management module may generate to indicate the risk appetite of an organization. In this example, a metric may include a risk outcome characteristic 1502 that associates the metric with one of the various risk outcomes. The metric may also include a key indicator characteristic 1503 that categorizes the metric as a key performance indicator (KPI) 1504, a key risk indicator (KRI) 1506, or a key control indicator (KCI) 1510. Key performance indicators may relate to business objectives of the organization and thus measure the performance of the organization against those objectives. Key risk indicators may relate to operational risk exposure and thus may be used to monitor, report, and forecast the risk exposure of the organization. Key risk indicators may predict areas in which operational risk necessitates remedial action that can reduce the risk exposure of the organization. Key control indicators may be employed to monitor a control of the organization and utilized to determine whether the control is performing as designed and to identify any change in the effectiveness of a control. In this regard, an organization may efficiently assess the status of their business goals, risk exposure, and control efforts.

The summary health report 1500 of FIG. 15 includes the number of metrics of each indicator type 1503 for each of the risk outcomes 1502. The summary health report 1500 in FIG. 15 also includes a visual indicator 1512 that visually indicates the health of the risk outcome 1502. The visual indicator 1512 may, for example, utilize color to indicate the health of the risk outcomes 1502. The metrics management module may determine the color of the visual indicator (e.g., green, yellow, or red) based on the aggregated health ratings for the metrics associated with the risk outcomes and various performance thresholds similar to the approach discussed above with reference to FIG. 8. The example summary health report 1500 also includes a visual indicator 1514 to visually indicate the health of the risk outcomes 1502 overall. In this way, the metrics management module advantageously provides a relatively quick and efficient way to assess the health of various risk outcomes related to the organization.

It will be understood with the benefit of this disclosure that the metrics management module may generate additional or alternative types of summary health reports based that include additional or alternative types of aggregate health ratings along additional or alternative dimensions. The metrics management module may generate, for example, summary health reports that include aggregate health ratings corresponding to the health of related controls and related control groups. Furthermore, additional or alternative characteristics may be associated with the metrics, controls, and control groups such that the metrics management module may determine the additional or alternative aggregate health ratings along the additional or alternative dimensions.

Aspects of the invention have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the invention.

What is claimed is:

1. A computer-implemented method for assessing the health of an organization comprising:
determining, at a processor of a metrics management system, a set of metric health ratings wherein individual metric health ratings in the set of metric health ratings respectively indicate metric health of individual metrics of the organization;
selecting, using the processor, a subset of metric health ratings from the set of metric health ratings;
determining, at the processor, a control health rating based, at least in part, on the subset of metric health ratings wherein the control health rating is one of a set of control health ratings and indicates control health of a control of the organization;
selecting, using the processor, a subset of control health ratings from the set of control health ratings;
determining, at the processor, a control group health rating based, at least in part, on the subset of control health ratings wherein the control group health rating is one of a set of control group health ratings and indicates control group health of a control group of the organization; and
determining an overall health rating that indicates organizational health of the organization based, at least in part, on the set of control group health ratings.

2. The computer-implemented method of claim 1 further comprising:
associating, using the processor, a metric characteristic with a plurality of metrics of the organization to establish a relationship between the metrics associated with the metric characteristic; and
determining, using the processor, a related metric health rating based, at least in part, on a plurality of metric health ratings that respectively correspond to the plurality of metrics associated with the metric characteristic.

3. The computer-implemented method of claim 1 further comprising:
associating, using the processor, a control characteristic with a plurality of controls of the organization to establish a relationship between the controls associated with the control characteristic; and
determining, using the processor, a related control health rating based, at least in part, on a plurality of control health ratings that respectively correspond to the plurality of controls associated with the control characteristic.

4. The computer-implemented method of claim 1 further comprising:
associating, using the processor, a control group characteristic with a plurality of control groups of the organization to establish a relationship between the control groups associated with the control group characteristic; and
determining, using the processor, a related control group characteristic based, at least in part, on a plurality of control group health ratings that respectively correspond to the plurality of control groups associated with the control group characteristic.

5. The computer-implemented method of claim 1 further comprising:
generating, using the processor, a summary health report based, at least in part, on at least one of the set of metric health ratings, the set of control health ratings, the set of control group health ratings, the overall health rating, and combinations thereof; and
transmitting the summary health report to a display device that displays the summary health report in response to receipt of the summary health report.

6. An apparatus for assessing the health of an organization comprising:
a processor; and
a memory configured to store computer-readable instructions that, when executed by the processor, cause the processor to perform a method comprising:
determining a set of metric health ratings wherein individual metric health ratings of the set of metric health ratings respectively correspond to individual metrics of a set of metrics of the organization;
selecting a subset of metric health ratings from the set of metric health ratings;
determining one or more aggregate health ratings based, at least in part, on the subset of metric health ratings wherein the one or more of the aggregate health ratings indicate at least a portion of the health of the organization;
generating a summary health report that includes one or more of the aggregate health ratings; and
transmitting the summary health report to a display device that displays the summary health report in response to receipt of the summary health report.

7. The apparatus of claim 6 wherein one of the aggregate health ratings is a related metric health rating and wherein the memory is configured to store computer-readable instructions that, when executed by the processor, cause the processor to further perform:
associating a metric characteristic with a plurality of metrics in the set of metrics to establish a relationship between the metrics associated with the metric characteristic; and
determining the related metric health rating based, at least in part, on one or more of the metric health ratings respectively corresponding to the plurality of metrics associated with the metric characteristic.

8. The apparatus of claim 6 wherein at least one of the aggregate health ratings is a control group health rating, wherein at least one of the aggregate health ratings is a control group health, and wherein the memory is configured to store computer-readable instructions that, when executed by the processor, cause the processor to further perform:
determining a set of control health ratings based, at least in part, on one or more of the metric health ratings in the subset of metric health ratings wherein individual control health ratings in the set of control health ratings respectively indicate health of individual controls of the organization; and
determining a set of control group health ratings based, at least in part, on one or more of the control health ratings in the set of control health ratings wherein individual control group health ratings in the set of control group health ratings respectively indicate health of individual control groups of the organization.

9. The apparatus of claim 8 wherein one of the aggregate health ratings is an overall health rating that indicates overall health of the organization and wherein the memory is configured to store computer-readable instructions that, when executed by the processor, cause the processor to further perform determining the overall health rating based, at least in part, on one or more of the control group health ratings in the set of control group health ratings.

10. A non-transitory computer-readable storage medium having computer-executable program instructions stored thereon that when executed by a processor cause the processor to perform steps for assessing organizational health of an organization, the steps comprising:
determining a set of metric health ratings wherein individual metric health ratings of the set of metric health ratings respectively indicate health of individual metrics of a set of metrics of the organization;
selecting a subset of metric health ratings from the set of metric health ratings; and
determining one or more aggregate health ratings based, at least in part, on the subset of metric health ratings wherein the one or more of the aggregate health ratings indicate the organizational health of at least a portion the organization.

11. The computer-readable storage medium of claim 10 wherein one of the aggregate health ratings is a related metric health rating and wherein the computer-executable instructions, when executed by the processor, cause the process to further perform:
associating a metric characteristic with a plurality of metrics in the set of metrics to establish a relationship between the metrics associated with the metric characteristic; and
determining the related metric health rating based, at least in part, on one or more of the metric health ratings respectively corresponding to the plurality of metrics associated with the metric characteristic.

12. The computer-readable storage medium of claim 11 wherein:
the plurality of metrics associated with the metric characteristic includes a first metric associated with a first control of the organization and a second metric associated with a second control of the organization;
the subset of metric health ratings includes a first metric health rating that corresponds to the first metric and a second metric health rating that corresponds to the second metric; and
the related metric health rating is determined based, at least in part, on the first metric health rating and the second metric health rating.

13. The computer-readable storage medium of claim 12 wherein the first control is associated with a first control group of the organization and the second control is associated with a second control group of the organization.

14. The computer-readable storage medium of claim 10 wherein one of the aggregate health ratings is a control health rating that indicates health of a control of the organization, wherein the subset of metric health ratings includes one or more metric health ratings that respectively correspond to metrics associated with the control, and wherein the computer-executable instructions, when executed by the processor, cause the process to further perform:
determining the control health rating based, at least in part, on one or more of the metric health ratings that respectively correspond to the metrics associated with the control.

15. The computer-readable storage medium of claim 14 wherein one of the aggregate health ratings is a related control health rating and wherein the computer-executable instructions, when executed by the processor, cause the process to further perform:
associating a control characteristic with a plurality of controls of the organization to establish a relationship between the controls associated with the control characteristic;
determining a plurality of control health ratings wherein individual control health ratings of the plurality of control health ratings respectively correspond to individual controls of the plurality of controls associated with the control characteristic; and
determining the related control health rating based, at least in part, on one or more of the control health ratings of the plurality of control health ratings.

16. The computer-readable storage medium of claim 15 wherein:
the plurality of controls associated with the control characteristic includes a first control associated with a first control group of the organization and a second control associated with a second control group of the organization;
the plurality of control health ratings includes a first control health rating that corresponds to the first control and a second control health rating that corresponds to the second control; and
the related control health rating is determined based, at least in part, on the first control health rating and the second control health rating.

17. The computer-readable storage medium of claim 14 wherein one of the aggregate health ratings is a control group health rating that indicates health of a control group of the organization and wherein the computer-executable instructions, when executed by the processor, cause the process to further perform:
determining a set of control health ratings that includes one or more control health ratings that respectively correspond to one or more controls associated with the control group; and
determining the control group health rating based, at least in part, on one or more of the control health ratings in the set of control health ratings.

18. The computer-readable storage medium of claim 17 wherein one of the aggregate health ratings is a related control group health rating and wherein the computer-executable instructions, when executed by the processor, cause the process to further perform:
associating a control group characteristic with a plurality of control groups of the organization to establish a relationship between the control groups associated with the control group characteristic;
determining a plurality of control group health ratings wherein individual control groups health ratings of the plurality of control group health ratings respectively correspond to individual control groups of the plurality of control groups associated with the control group characteristic; and
determining the related control group health rating based, at least in part, on one or more of the control group health ratings of the plurality of control group health ratings.

19. The computer-readable storage medium of claim 17 wherein one of the aggregate health ratings is an overall health rating that indicates overall health of the organization and wherein the computer-executable instructions, when executed by the processor, cause the process to further perform:
determining a set of control group health ratings that includes one or more control group health ratings respectively corresponding to one or more control groups of the organization; and
determining the overall health rating based, at least in part, on one or more of the control group health ratings in the set of control group health ratings.

20. The computer-readable storage medium of claim 14 wherein the subset of metric health ratings includes an efficiency metric associated with the control and an effectiveness metric associated with the control and wherein the computer-executable instructions, when executed by the processor, cause the process to further perform:
determining an efficiency rating for the control based, at least in part, on the efficiency metric;
determining an effectiveness rating for the control based, at least in part, on the effectiveness metric; and
wherein the control health rating is the arithmetic mean of the efficiency rating and the effectiveness rating.
